(19) United States
(12) Patent Application Publication
(10) Pub. No.: US 2004/0081738 A1
(43) Pub. Date: Apr. 29, 2004

(54) Method of producing novel pasta and masa like doughs and products produced therefrom

(76) Inventors: Annavarapu S. Murty, Spring Valley, WI (US); Madonna M. Ray, Vadnais Heights, MN (US); Jean L. Weber, Plymouth, MN (US)

Correspondence Address: GENERAL MILLS, INC., P.O. BOX 1113, MINNEAPOLIS, MN, 55440, US

(21) Appl. No.: 10/278,253

(22) Filed: Oct. 23, 2002

(51) Int. Cl. A23L 1/00

(52) U.S. Cl. 426/557

(57) ABSTRACT

This invention is directed to a method of making a refrigerated fresh pasta like dough or refrigerated fresh corn masa dough in which a portion of the wheat flour is replaced with semolina flour or masa flour respectively. The dough may further include chemical leaveners. The chemical leaveners are those that would typically be found in refrigerated baked goods and include acidulants and a base. The resulting dough, when it includes leaveners, can be successfully packaged into a refrigerated can and provides the consumer with the ability to have fresh dough on hand in the refrigerator. The invention is further directed to a pasta or corn dough product resulting from the method.

### CROSS-REFERENCES TO RELATED APPLICATIONS

Not applicable.

### FIELD OF THE INVENTION

The present invention relates to a method for providing fresh pasta and masa dough without suffering from the drawbacks usually associated with the preparation of most pasta and masa products. The present invention is directed to the preparation of a dough having fresh pasta like and other desirable characteristics, one that can be made into any shape, by manipulation of the flour content and the use of leaveners. Through the use of a unique combination of flours, shelf stability, texture and freshness, fresh pasta or masa like characteristics can be obtained.

### BACKGROUND OF THE INVENTION

Traditionally, freshly prepared pasta and masa doughs do not keep for any length of time and the doughs must be made into products straightaway and then baked and cooked in order to produce pasta or masa products of a suitable consumable freshness and quality. In those instances where the consumer wishes to purchase fresh pasta dough or fresh masa dough, rather than making it fresh, the dough has to be used immediately after purchase, optionally shaped into the desired products, and then baked or cooked. Currently, while there are refrigerated fresh pasta offerings, the product is preshaped amd cannot be used other than for the purposes intended. In addition, there are no products available in the marketplace today that can be stored for an extended period of time under refrigerated conditions thereby providing the consumer with a useful alternative to either having to purchasing fresh pasta or fresh masa doughs on an as-needed-basis or produce small batches of such dough when a recipe calls for such ingredients or components.

As such, food product companies, in order to accommodate consumers need for pasta and masa products, the pasta and masa products are dehydrated to improve shelf life. In order to use such products, the purchaser must hydrate the products prior to consumption. However, while this process may meet the limited needs of market place, such products do not offer the freshness desired by many sophisticated consumers and can produce a stale taste on one's palate. In addition, such products are often rigid and fragile and can break during shipping or handling, thereby leaving the consumer with a carton full of broken pieces, such as with lasagna noodles and the like.

There is a recognized need in the market place, for convenient multi-component food preparation in the home. Ideally, products that are convenient for these purposes would likely need to be adapted for refrigeration for a period of time until they are required by the consumer. In addition, the products should still have the particular characteristics that are needed by the recipe and provide the attributes desired by the consumers, namely freshness and taste. In some cases, products such as fresh pasta or masa dough will not keep under normal refrigeration conditions and need to be used immediately.

It is therefore an object of the invention to provide a consumer with a refrigerated pasta or masa dough alternative that can be refrigerated and stored for a period of time in a standard refrigerator prior to use and one that will have the desired qualities of freshly prepared pasta or masa doughs.

### BRIEF SUMMARY OF THE INVENTION

In one embodiment of the present invention a method of preparing a refrigerated wheat flour dough based intermediate is described comprising the steps of initially providing an amount of a first flour. Then, the first flour is mixed with an amount of a second flour selected from a group including semolina flour, masa flour, barley flour, rice flour or corn flour and mixtures thereof and finally, an intermediate is prepared by blending the first flour with the second flour along with a select group of ingredients such that an intermediate is formed that is useful and stable as a refrigerated dough product and has improved extensibility, texture and shelf life.

It is preferred in the above method that the wheat flour is a hard spring or winter wheat flour and that the amount of the second flour, such as semolina flour or masa flour may comprise up to 90% of the total amount of flour in the dough product. The second flour is selected for certain attributes relating the ability to entrap gas and extensibility and elasticity.

Additionally, the above method may further include the steps of adding an amount of a leavening agent comprising a leavener acid and a leavener base during preparation of the dough product. Further, an amount of gluten may be added during preparation of the masa dough product or intermediate, as well as an amount of salt may be included during preparation of the dough product or intermediate.

Additionally, the method preferably includes the further step of sheeting the dough product and/or packing the dough product in a pressurized refrigerated baked goods can, such that the packaging is suitable for storing the dough product under refrigeration conditions for 75-105 days. The method may also include the further step of proofing the dough product.

In a related aspect, the present invention provides a refrigerated wheat flour product prepared according to the method defined above.

In a still further embodiment of the present invention a dough based intermediate product suitable for refrigeration and storage in a refrigerated baked goods can is described and includes at least a first portion of a wheat flour; a second portion of a second flour distinct from the first portion, the second flour selected from masa flour, semolina flour and combinations thereof. A liquid capable of forming a matrix is included in the mixture. In addition, a chemical leavening agent containing an acid and a base component is also added. In use, each portion of each of the first and second flours and liquid is selected to provide a combination that creates a consistency for an intermediate that can be kneaded or rolled.

The refrigerated wheat flour based dough product may further include an amount of gluten and/or salt in the masa dough product.

Further embodiments of the present invention, without limitation, will become apparent from the following figures, detailed description and examples.

### BRIEF DESCRIPTION OF THE DRAWINGS

The foregoing, as well as other objects and advantages of this invention, will be more completely understood and appreciated by referring to the following more detailed description of the presently preferred exemplary embodiments of the invention in conjunction with the accompanying drawings, of which:

FIG. 1 is a is a visual comparison of the use of two different leavening systems and their effect on can pressure when refrigerated doughs of the present invention are packaged in a refrigerated baked goods can; and

FIG. 2 is a graph depicting the performance of the formula of the present invention compared with an existing refrigerated dough product.

The foregoing and other objects of the invention will become clear from an inspection of the detailed description of the invention and from the appended claims.

### DETAILED DESCRIPTION OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

As used herein, the term “intermediate” or “dough intermediate” refers to a dough product that is capable of undergoing one or more further treatment steps, such as baking, cooking, heating, steaming, etc. to produce a finished food product.

Most doughs, such as a bread dough, are comprised substantially of, if not entirely made of a single flour such as a wheat or other cereal based flour. While such doughs are capable of being frozen for use at a later time, the applicant has made the surprising discovery that the replacement or substitution of a portion of wheat flour including up to a substantial portion of the total amount of the two flours, with a second flour, such as masa flour, the resulting dough provides a dough product or intermediate that is capable of being refrigerated and that has com-tortilla like physical attributes. The portion of the wheat flour that is substituted with the masa flour is less than 100%. When masa flour is used to replace a portion of the wheat flour in the dough products the dough based product is suitable for the preparation of tortilla like products. Such tortilla like products include tortillas, tortilla chips, tortilla salad bowls, tamales and hard and soft taco shells.

Similarly, the applicant has also found that the replacement or substitution of a portion of wheat flour with a second flour, such as semolina flour, the resulting product provides a pasta like dough product or intermediate that is capable of being refrigerated and that has pasta like physical attributes. When semolina flour is used to replace a portion of the wheat flour in the dough product the product is suitable for the preparation of pasta products. Such pasta products include lasagna, fettuccine, cannelloni, manicotti, radiatore, ziti, egg noodles and the like.

The dough prepared in accordance with the present invention provides the benefits of greater flexibility and allows some stretching, such as may be required when wrapping the dough around ingredients, such as meats, cheeses, sauces, vegetables and the like, or simply to fill the interior of the cooking vessel. This can be considerably more advantageous when preparing such items as ravioli, fajitas, enchiladas and the like.

In one exemplary embodiment, the pasta flour prepared in accordance with the present invention is particularly desirable in making lasagna, in that it can be stretched to cover the interior of the cooking vessel or baking pan as well as the layers of the lasagna recipe. In addition, the dough prepared in connection with this invention have been found to have a fresher texture than conventional pasta products, such as those that are dehydrated. Furthermore, it has been found that the dough of the present invention can have some color imparted to the doughs to enable the dough to blend aesthetically with the remaining ingredients or components, for example, dough may have a reddish color to blend with the tomato based sauces.

The present invention also contemplates that unique textures can be created, for example, masa dough, can be provided with a more real corn taste as opposed to traditional masa products, or the doughs can have the appearance of having other grains or cereals present in the dough. Moreover, designs can be incorporated into the pasta and masa dough such as holiday and ethnic patterns or symbols.

A Wheat Flour Based Dough Products.

It is preferred that the wheat flour is a hard spring wheat flour or hard winter wheat flour and that the amount of wheat flour ranges from between 10% to 50% of the total amount of flour in the dough product or intermediate. Hard spring wheat flour contains a high protein content (13-16.5%) making it suitable for use as a bread wheat as it has good milling and baking characteristics. Hard winter wheat flour is the class of wheat flour that is also commonly used for bread and in connection with the present invention, a wheat flour having a medium to high protein content (10-13.5). Wheat flour is preferable for use as the first flour in the embodiments described herein as it is used in forming a dough that can be manipulated by the consumer.

B Semolina Flour.

Semolina flour is obtained from the purified middlings from the durum wheat and is the highest protein flour and has been traditionally the most desirable flour for making shaped pasta. It is a coarsely ground product from the endosperm of durum wheat. Macaroni and spaghetti are traditionally made from semolina flour. While cooking, pasta made from semolina retains its shape and firmness and does not become mushy or sticky. The amount of semolina flour in the mixture can range from 50% to 90% of the total amount of flour used in preparing the intermediate or dough product.

C Masa Flour

Masa flour is the traditional flour used to make corn tortillas The flour is obtained from sun-dried corn kernels, which are cooked and soaked in limewater overnight and then ground into masa flour. The amount of masa flour that is employed in the present invention has been found to vary the amount of carbon dioxide that is ultimately held in the gluten matrix of the dough. The maximum level of masa may be chosen depending on the desired flavor that is sought and also if it is desirable to optimize the amount of carbon dioxide that is retained in the gluten matrix and can range from 50% to 90% of the total amount of flour used in the preparation of the dough intermediate or product.

D Tortilla products.

In the present invention the term “tortilla like” means tortillas, tamales and the like products that can be produced when an amount of masa flour is used as the second flour to replace a portion of the wheat flour in the dough product. Such tortilla like products include but are not limited to tortillas, tortilla chips, tortilla salad bowls, tamales and hard and soft taco shells. See for example, Betty Crocker's Mexican Made Easy, General Mills, Inc., 1993. Prentice Hall General Reference, New York, and Authentic Mexican Regional cooking from the Heart of Mexico, Rick Bayless with Deann Groen Bayless. 1987, William Morrow and Compancy, Inc., New York.

F Pasta Products

In the present invention pasta products can be produced when an amount of semolina flour is used as the second flour to replace a portion of the wheat flour in the dough product. Such pasta products include but are not limited to lasagna, fettuccine, cannelloni, manicotti, radiatore, ziti, egg noodles and the like. See for example: Betty Crocker's Pasta Favorites, Prentice Hall, 1993. General Mills Inc., Mpls, Minn.

G Leavening Agents

Leavening agents are used to generate an amount of carbon dioxide in a dough product. The rate of reaction of the leavening agents and therefore the release of carbon dioxide will affect the characteristics of a dough and baked product. This rate of reaction depends on the basic chemical and physical characteristics of the leavening acid, leavening base and rates of release of carbon dioxide can vary widely. In the present invention, chemical leaveners may be used to not only capture an amount of carbon dioxide in the dough, but also to aid in the generation of a positive pressure in a can into which the dough product is optionally packaged. The positive pressure in the can aids in the storability or shelf life of the dough product under refrigeration conditions. The shelf life of the present invention can extend for approximately 90 days.

Leavening agents require the presence of an acid and a base. The choice and quantity of leavening acid can have significant impact on color, flavor, pH, texture, crumb characteristics and the like of a dough product. If too much leavening acid is used, for example, residual acidity will be too high and tartness will result. If too little is used, the proportion of sodium bicarbonate may be too high, and the finished product will have a soapy, alkaline flavor. It would be clear to someone skilled in the art of preparing doughs how to select appropriate leavening agents for the particular purpose required.

In the present invention the leavener acid is preferably selected from sodium acid pyrophosphate (SAPP), sodium aluminum phosphate (SALP), glucono-delta lactone, monocalcium phosphate, dicalcium phosphate, diammonium phosphate, fumeric acid, adipic acid, sodium aluminum sulphate, cream of tartar (monopotassium tartarate) and the like and combinations thereof, and the leavener base is selected from sodium and potassium bicarbonate and combinations thereof.

H Gluten.

Gluten is a protein found in wheat, rye, barley, and oats. It is the gluten in the flour that helps bread and other baked goods bind and prevents crumbling. This feature has made gluten widely used in the production of many processed and packaged dough based foods. The inclusion of gluten in the dough assists in controlling the extensibility of the resulting dough and also the ability of the dough to retain carbon dioxide in the dough matrix.

I Salt.

The use of salt in the present invention ranged in an amount of approximately between 1-1.5% by weight of the total weight of ingredients combined in the dough preparation steps. The use of the salt reduced the water activity of the resulting dough. An exemplary salt is un-iodized sodium chloride.

J Fat

The preferred fat that is optionally used in the dough preparation stage is soybean oil. It is to be appreciated that other plant derived fats that are commonly used in the dough preparation industry could also be employed. Such fats include: cottonseed, canola, coconut, corn, peanut and palm. The inventors have found that when soy oil is used it may be used in amounts up to 10% by weight of the total weight of ingredients combined in the dough preparation steps. However, the level of oil that is employed has been found to vary the ability of the gluten/dough matrix to retain carbon dioxide in the dough. Where more than 5% of oil was utilized, it was found by the inventors that the resulting dough product tended to become more fragile and more likely to be torn during rolling and packaging. Preferably, up to 2% by weight of the total weight of ingredients combined in the dough preparation steps was used in the preparation of the dough products.

K Packaging.

In the present invention the preferred storage means for a dough prepared by the present invention are refrigerated baked goods cans. An exemplary can construction consists of a coated or lined paperboard material which is formed into a container and provided with one or more end caps, usually made of a metal such as aluminum or other rigid material. The cans are adapted such that the can may be sealed after packing and should be such that they can retain any positive pressure that is generated by the dough itself. Preferably the cans are adapted to be able to retain a positive pressure of at least 20 to 30 psi. In the present invention cylindrical paperboard cans such as that described in U.S. Pat. No. 5,251,809 are used.

L Storage

Preferably, the dough and packaging container are stored under refrigeration conditions in a baked goods can at a temperature of 35-50 F. The preferred shelf life of the dough when packaged is between 60-90 days but can be as long as 105 days. The shelf life of the product depends on the positive pressure that is generated by the dough as a result of the leaveners and carbon dioxide that is physically retained in the dough matrix after processing.

The present invention is now illustrated in greater detail by way of the following examples, but it should be understood that the present invention is not to be construed as being limited thereto.

### EXAMPLE 1

Refrigerated Pasta Dough.

A refrigerated pasta dough can be made for use in Italian food, such as lasagna, and the like, for storage in a pressurized dough can. In essence this embodiment enables one to effectively preserve a fresh pasta-like product in a can. A refrigerated pasta dough in accordance with the present invention can be made using the following ingredients.

| Ingredients | Weight (gms) | % |
|---|---|---|
| Semolina | 2634 | 43.9 |
| Flour | 1319 | 22 |
| Water | 1800 | 30 |
| Salt | 90 | 1.5 |
| Sodium Acetate Pyrophosphate (SAPP)- | 62 | 1.03 |
| leavening agent | | |
| Sodium Aluminum Phosphate (SALP)- | 24 | 0.4 |
| Leavening agent | | |
| Soda | 44 | 1.18 |

The flour/water ratio is (4008/2000)=2.00 (Flour=semolina+flour)

The actual process of making this dough involves the following steps

1 At a slow mixing speed mixing the flour/semolina/gluten for 60 seconds.

2 Adding water and mixing for a further 60 seconds at slow speed.

3 At high speed mixing for 120 seconds.

4 Adding leaveners and salt and mixing for another 120 seconds.

5 Allowing the dough to “rest” from 0-15 minutes before forming the dough into

The sheeted product was then packed into a can and proofed for 3 hours at room temperature and then transferred to the refrigerator.

The sheeting procedure involved the following steps:

1 Loading the dough into an extruder;

2 Extruding the dough onto a floured belt;

3 Passing the dough through reducing rollers to achieve the desired thickness, the preferred thickness range is between 1.0-2.0 mm;

4 Passing the sheeted dough under a metal check station;

5 Applying a separating agent to the surface of the dough;

6 Cutting the sheeted dough into pads with 6 equal pieces per pad, preferably the size of each pad is 7-8 inches by 21-24 inches;

7 Targeting the weight of each pad to approximately 267 grams;

8 Rolling the pads up and placing into refrigerated baked goods cans, preferably having a size of 112 mm by 700 mm. The average pressure in the cans ranges from 8 to 12 psi.

9 Seaming the cans and packing the cans into boxes for storage purposes.

It has been found that the following variables can be exploited to adapt the resulting dough for storage in a can: The use of hard wheat flour and gluten to provide extensibility to the dough; the use of leaveners to produce a positive pressure in the can, which is important for ultimate product shelf life, and salt to reduce water activity.

### EXAMPLE 2

Refrigerated Corn Masa Dough

A refrigerated corn masa dough may be made for use in Mexican food, such as tortillas, and the like, for storage in a can. In essence this embodiment enables one to effectively preserve a fresh corn masa dough product in a can.

| Ingredients | Weight (gms) | % |
|---|---|---|
| Masa | 1602 | 26.7 |
| Flour | 1601 | 26.7 |
| Gluten | 120 | 2 |
| Water | 2340 | 39 |
| Soy Oil | 120 | 2 |
| Salt | 60 | 1 |
| Sodium acid pyrophosphate (SAPP)- | 62 | 1.03 |
| Leavening agent | | |
| Sodium Aluminum Phosphate (SALP)- | 24 | 0.4 |
| Leavening agent | | |
| Soda | 44 | 1.18 |

The flour/water ratio is (3408/2400)=1.42 (Flour=masa+flour+gluten)

The actual process of making this dough involved the following steps

1 At a slow mixing speed mixing the flour/masa/gluten for 60 seconds;

2 Adding water and mixing for a further 60 seconds at slow speed;

3 At high speed mixing for 120 seconds;

4 Adding leaveners and salt and mixing for another 120 seconds;

5 Allowing the dough to “rest” from 0-15 minutes before forming the dough into sheets.

The sheeted product was then packed into a can and proofed for 3 hours at room temperature and then transferred to the refrigerator.

The sheeting procedure involved the following steps:

1 Loading the dough into an extruder;

2 Extruding the dough onto a floured belt;

3 Passing the dough through reducing rollers to achieve the desired thickness, the preferred thickness range is between 1.0-2.0 mm;

4 Passing the sheeted dough under a metal check station;

5 Applying a separating agent to the surface of the dough;

6 Cutting the sheeted dough into pads with 6 equal pieces per pad, preferably the size of each pad is 7-8 inches by 21-24 inches;

7 Targeting the weight of each pad to approximately 267 grams;

8 Rolling the pads up and placing into refrigerated baked goods cans, preferably having a size of 112 mm by 700 mm;

9 Seaming the cans and packing the cans into boxes for storage purposes.

It has been found that the following variables can be exploited to adapt the resulting dough for storage in a can: The use of hard wheat flour and gluten to provide extensibility to the dough; the use of leaveners to produce a positive pressure in the can, which is important for product shelf life; and salt to reduce water activity.

To determine the effect of the leaveners on the resulting ability of the dough to achieve a positive can pressure in a refrigerated baked goods can, the following experiments were conducted. The different batches of dough for each of these experiments were prepared and mixed in the same manner as described above in Example 2.

The following batch experiments 1-4 for the corn masa dough in a 50:50 ratio with the wheat flour employed the following ingredients:

| | Masa | Flour | Gluten | Water | Soy Oil | Salt | SAPP | SALP | Soda |
|---|---|---|---|---|---|---|---|---|---|
| Batch | (grams) | (grams) | (grams) | (grams) | (grams) | (grams) | (grams) | (grams) | (grams) |
| 1 | 1644 | 1644 | 120 | 2399.4 | 0 | 60 | 89.04 | 0 | 43.56 |
| 2 | 1614 | 1614 | 120 | 2399.4 | 120 | 60 | 89.04 | 0 | 43.56 |
| 3 | 1632 | 1632 | 120 | 2399.4 | 0 | 60 | 61.8 | 24 | 70.8 |
| 4 | 1602 | 1602 | 120 | 2399.4 | 120 | 60 | 61.8 | 24 | 70.8 |

The following batch experiments for the corn masa dough in a 75:25 ratio with the flour employed the following ingredients:

| | Masa | Flour | Gluten | Water | Soy Oil | Salt | SAPP | SALP | Soda |
|---|---|---|---|---|---|---|---|---|---|
| Batch | (grams) | (grams) | (grams) | (grams) | (grams) | (grams) | (grams) | (grams) | (grams) |
| 5 | 822 | 2466 | 120 | 2399.4 | 0 | 60 | 89.04 | 0 | 43.56 |
| 6 | 807 | 2421 | 120 | 2399.4 | 120 | 60 | 89.04 | 0 | 43.56 |
| 7 | 816 | 2448 | 120 | 2399.4 | 0 | 60 | 61.8 | 24 | 70.8 |
| 8 | 801 | 2403 | 120 | 2399.4 | 120 | 60 | 61.8 | 24 | 70.8 |

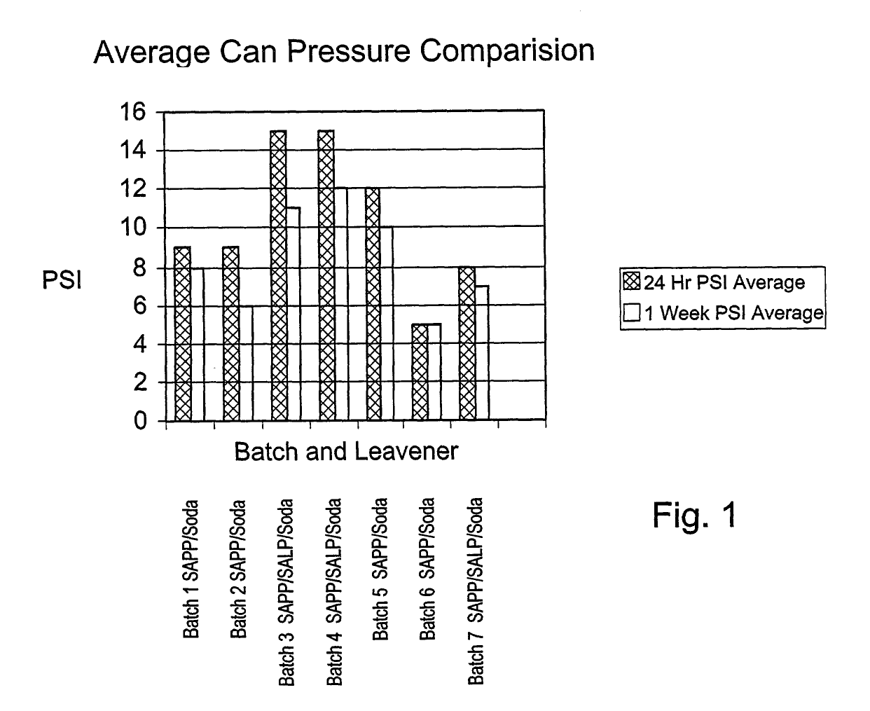

The results of the different leavening systems can be seen in FIG. 1. It is clear that increased pressure in the dough can may be achieved in a refrigerated baked goods can by modifying the leavening agents employed thus ensuring shelf stability. Dough can pressure of a masa based product was measured and compared to a current shelf stable refrigerated dough product (crescent roll dough) as can be seen from the following table.

| | | Crescent | |
|---|---|---|---|
| Masa Dough | | Dough | |
| 24 hr | 1 wk | 24 hr | 5 wk |
| 14 | 11 | 22.5 | 16.8 |
| 15 | 13 | 26 | 18.8 |
| 15 | 12 | 23.6 | 18.3 |
| 16 | 14 | 22.5 | 16.8 |
| 16 | 13 | 25.4 | 19.3 |
| 15 | 12 | 24.2 | 18.3 |
| 15 | 11 | 24.7 | 16.8 |
| 15 | 11 | 21.4 | 17.8 |
| 13 | 12 | 21.4 | 17.3 |
| 15 | 10 | 19.8 | 17.8 |
| 15 | 12 | 18.75 | 15.8 |
| 13 | 11 | 20.3 | 16.8 |
| 15 | 11 | 25.4 | 19.3 |
| 15 | 12 | 24.8 | 18.3 |

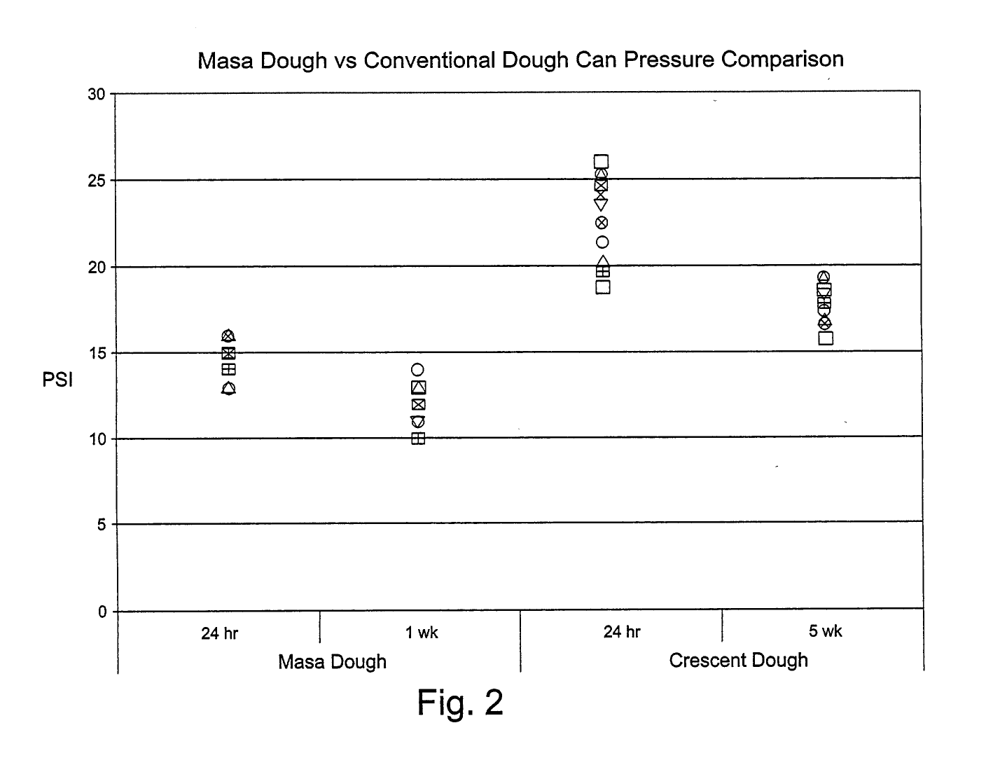

FIG. 2 provides a further depiction of the results in an exemplary graph plotted in connection with the foregoing table, where a dough can containing masa dough is compared to dough can containing a known shelf-stable refrigerated dough product, crescent dough available from The Pillsbury Company, a division of General Mills, Inc. Minneapolis, Minn. 55426. As illustrated in the chart, the pressure in the dough can for the masa dough ranges from 13 to 16 psi at 24 hours and from 10 to 14 psi at one week. The crescent dough ranges from 18.87 psi to 25.4 psi at 24 hours and 15.8 to 19.3 psi at 5 weeks.

In the present example, the masa dough undergoes development in the can and achieves a sufficient equilibrium in the container for the dough to continue to rise and fill the container, without creating extreme pressure to rupture the container (pressures beyond about 25 psi). About 85-99 percent of the available volume of the dough can is filled with masa dough and the container subject to heating. By elevating the temperature, the leaveners in the dough act more quickly than if the dough remained at room temperature. Once the dough has filled the container, it is placed in refrigerated storage allowing the dough to gradually continue to rise until reaching its target equilibrium. A dough which is capable of achieving an adequate pressurization then provides a product that has the proper texture, taste and density as well as adequate shelf life in that the can does not rupture and there is virtually no exchange of gases with the external environment.

The benefits of the pasta dough or masa dough made according to the Examples and batches as described above, include the fact that the dough needs less processing than either traditional pasta or masa doughs in that processing time is reduced from hours to minutes. The dough can be produced in sheets and can be easily rolled and inserted into a can. Additionally, the sheets can be easily separated from each other after removal from the can, through the use of die cuts, perforation lines, or the like that enable the sheets to be separated into individual segments or portions from one another.

Furthermore, the use of semolina flour to make pasta based products provides authentic pasta texture and pasta flavor like qualities to the pasta dough. Similarly, the use of masa flour enables the development or provision of authentic corn taste and texture qualities normally associated with masa flour based products such as tortillas.

The dough sheets provide greater flexibility and allow some stretching as opposed to the traditional pasta/masa doughs. The dough sheets can be easily spread to fit the likes of a baking pan. Traditionally, pasta sheets or flour tortillas often tear upon stretching.

Finally, the end product is delivered to the consumer in a can, which is adapted to be refrigerated for a period of time. The dough can then be taken from the refrigerator when required and fresh pasta or fresh masa products can be made from the dough. This provides the consumer with a useful substitute to having to purchase the fresh pasta or masa products immediately prior to use.

The dough products fit well with the current trend of consumers to have convenient multi-component food preparation available in the home.

It is to be appreciated that the refrigerated canned doughs could either be sold as a stand alone item or as part of a kit for making a full Italian or Mexican based meal.

Publications, patents and patent applications are referred to throughout this disclosure. All references cited herein are hereby incorporated by reference.

It will thus be seen according to the present invention a highly advantageous method of producing fresh masa and pasta dough has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

1. A method of preparing a refrigerated dough based intermediate product suitable for use as a pasta or masa dough including the steps of;
i) providing an amount of a first flour;
ii) mixing said first flour with an amount of a second flour selected from a group including semolina flour, masa flour, barley flour, rice flour, corn flour and combinations thereof; and
iii) preparing an intermediate by blending said first flour with said second flour and a select group of ingredients; and wherein said intermediate is formed and is useful as a refrigerated dough intermediate having improved extensibility, texture and shelf life.

2 The method of preparing a refrigerated dough based intermediate product according to claim 1, wherein said first flour is selected from hard spring wheat flour, winter wheat flour and combinations thereof.

3 The method of preparing a refrigerated dough based intermediate product according to claim 1, wherein the amount of said second flour comprises up to 90% by weight of said first and second amounts of said first and second flour in said dough based intermediate.

4 The method according to claim 3, wherein the amount of said second flour comprises between 50-75% by weight of said first and second amounts of said first and second flour in said dough based intermediate.

5 The method of preparing a refrigerated dough based intermediate product according to claim 1, wherein said second flour is semolina flour.

6. The method of preparing a refrigerated dough based intermediate product according to claim 1, wherein the method further includes the step of adding an amount of a leavening agent during preparation of the dough based intermediate, said leavening agent comprising a leavener acid and a leavener base.

7. The method of preparing a refrigerated dough based intermediate product according to claim 6, wherein the leavener acid is selected from sodium acid pyrophosphate, sodium aluminum phosphate, glucono-delta lactone, monocalcium phosphate, dicalcium phosphate, diammonium phosphate, fumeric acid, adipic acid, sodium aluminum sulfate, cream of tartar (monopotassium tartarate) and combinations thereof.

8. The method of preparing a refrigerated dough based intermediate product according to claim 6, wherein the leavener base is selected from sodium and potassium bicarbonate.

9. The method of preparing a refrigerated dough based intermediate product according to claim 1, wherein the method further includes a step of adding an amount of gluten during preparation of the masa dough based intermediate.

10. The method of preparing a refrigerated dough based intermediate product according to claim 1, wherein the method further includes a step of adding an amount of salt during preparation of the dough based intermediate.

11. The method of preparing a refrigerated dough based intermediate product according to claim 1, wherein the method further includes a step of sheeting the dough based intermediate.

12. The method of preparing a refrigerated dough based intermediate product according to claim 1, wherein the method further includes a step of packing the dough based intermediate in a refrigerated baked goods can.

13. The method of preparing a refrigerated dough based intermediate product according to claim 1, wherein the method includes a further step of proofing the dough based intermediate.

14. The method of preparing a refrigerated dough based intermediate product according to claim 1, wherein the method further includes a step of storing the refrigerated dough based intermediate under refrigeration conditions for up to 105 days.

15. The method of preparing a refrigerated dough based intermediate product according to claim 1, wherein the method further includes a step of making pasta products when the second flour is semolina flour and is used with said first flour in the dough based intermediate.

16 The method of preparing a refrigerated dough based intermediate product according to claim 15, wherein the pasta products include lasagna, fettuccine, cannelloni, manicotti, radiators, ziti, egg noodles and the like.

17. The method of preparing a refrigerated dough based intermediate product according to claim 1, wherein the method further includes a step of making tortilla products when the second flour is masa flour and is used with said first flour in the dough based intermediate.

18. The method of preparing a refrigerated dough based intermediate product according to claim 17, wherein the tortilla products include tortillas, tortilla chips, tortilla salad bowls, tamales and hard and soft taco shells.

19. A refrigerated dough based intermediate product when prepared by the method according to claim 1.

20. A refrigerated dough based intermediate product suitable for refrigeration and storage in a refrigerated baked goods can and for use as a pasta or masa dough including;
i) at least a first portion of a wheat flour;
ii) a second portion of a second flour distinct from said first portion, said second flour selected from masa flour, semolina flour, rice flour, barley flour, corn flour and combinations thereof;
iii) a liquid capable of forming a matrix;
iv) a chemical leavening agent containing an acid and a base component; and
wherein in use each portion of each of said first and second flours and said liquid is selected to provide a combination to create a consistency for an intermediate that can be kneaded or rolled.

21. The refrigerated dough based intermediate product according to claim 20, wherein the wheat flour is selected from hard spring wheat flour, winter wheat flour and combinations thereof.

22. The refrigerated dough based intermediate according to claim 20, wherein the portion of said second flour comprises up to 90% by weight of the first and second portions of said first and second amounts of flour in the dough based intermediate.

23. The refrigerated dough based intermediate according to claim 22, wherein the portion of the portion of the second flour comprises between 50-75% by weight of said first and second portion of said first and second flour in the dough based intermediate.

24. The refrigerated dough based intermediate according to claim 20, wherein the dough based intermediate includes a leavening agent having an acid and a base.

25. The refrigerated dough based intermediate according to claim 24, wherein said acid component is selected from sodium acid pyrophosphate, sodium aluminum phosphate, glucono-delta lactone, monocalcium phosphate, dicalcium phosphate, diammonium phosphate, fumeric acid, adipic acid, sodium aluminum sulfate, cream of tartar (monopotassium tartarate) and combinations thereof.

26. The refrigerated dough based intermediate according to claim 24, wherein said base component is selected from sodium and potassium bicarbonate.

27. The refrigerated dough based intermediate according to claim 20, wherein said liquid capable of forming a matrix is water.

28. The refrigerated dough based intermediate according to claim 20, wherein said liquid capable of forming a matrix is milk

29. The refrigerated dough based intermediate according to claim 20, further including an amount of gluten in the masa dough based intermediate.

30. The refrigerated dough based intermediate according to claim 20, further including an amount of salt in the dough based intermediate.

31. The refrigerated dough based intermediate according to claim 20, wherein when masa flour is used as said second flour in the dough based intermediate the first and second flour is suitable for preparation of tortilla like products.

32. The refrigerated dough based intermediate according to claim 31, wherein the tortilla like products include tortilla chips, tortilla salad bowls and hard and soft taco shells and combinations thereof.

33. The refrigerated dough based intermediate according to claim 20, suitable wherein when semolina flour is used as the second flour in the dough based intermediate and the first and second flour is suitable for preparation of pasta products.

34. The refrigerated wheat flour dough based intermediate according to claim 33, wherein the pasta products include lasagna, fettuccine, cannelloni, manicotti, radiators, ziti, egg noodles and combinations thereof.
